(19) United States
(12) Patent Application Publication
(10) Pub. No.: US 2007/0001340 A1
(43) Pub. Date: Jan. 4, 2007

(54) Method for ageing a package of stones

(75) Inventors: Richard Ludovicus Aldegond Clijsters, Dilsen-Stokkem (BE); Erik Maria Willy van Eynde, Westerio (BE)

Correspondence Address: TROUTMAN SANDERS LLP, 600 PEACHTREE STREET , NE, ATLANTA, GA, 30308, US

(73) Assignee: Overlaat Beheer B.V., Drunen (NL)

(21) Appl. No.: 10/547,491

(22) PCT Filed: Feb. 26, 2004
(86) PCT No.: PCT/IB04/00889

§ 371 Date: Aug. 29, 2006

(30) Foreign Application Priority Data
Mar. 4, 2003 (NL) 1022840

(51) Int. Cl. B28D 1/00; B28B 11/18; E04B 1/00

(52) U.S. Cl. 264/162; 52/741.1; 125/1

(57) ABSTRACT

A device (1) for ageing a package of stones comprises a cage (24) for locking the package of stones with play being present. For the purpose of the ageing process of the stones, the cage (24) is suspended in a frame (30) which is rotatable about a rotation axis (55). During a rotary movement of the frame (30) and the cage (24), the stones collide against each other, and outer stones of the package additionally collide against plates (21,22,23) of the cage (24). The play between the package of stones and the cage (24) is chosen such that the stones have space to move on the one hand, and that the position and the orientation of the stones in the package are maintained on the other hand Consequently, after the ageing process has finished, the stones can be removed from the ageing device (1) as an ordered package.

The present invention relates to a method for ageing a package of stones. By a package of stones, a collection of a number of stones is meant, which are piled on top of each other and which are adjacent to each other. A package of stones comprises at least two adjacent columns of at least two stones piled on top of each other.

In a package of stones, all stones can be orientated in a similar manner, but this is not necessary. It is also possible that the stones in the package are piled crosswise, wherein the orientation of stones is different for different layers of the package of stones. For example, the stones may have two different orientations, wherein, for example, the orientation of the stones may change per layer or per two layers of the package.

Usually, stones are manufactured of a mixture of sand, gravel, cement, colorant and water. During the manufacturing process, the mixture is pressed in a mould on a shelf, after which the shelf is placed in a drying space. After a first drying process has taken place in the drying space, the stones are piled in a package by a packaging machine. The stones are packed by means of arranging plastic ribbons around the package. Before the stones are ready for application, the entire package is subjected to a further drying process.

For the purpose of certain applications of stones, especially for paving, it is desirable that the stones have a natural appearance. Such an appearance is obtained by ageing the stones during a last step of the manufacturing process. It is common practice to subject the stones to a tumbling process in order to obtain an aged appearance. For the purpose of such a tumbling process, a number of stones is placed in a drum, which is rotated, wherein the stones collide against each other and walls of the drum. Consequently, the stones receive damages all around, wherein grooves and scratches appear on the surface of the stones, and wherein small pieces fly off the corners and edges. After the tumbling process, the stones are dumped in a so-called big bag or in a truck, so that they can be transported to one or more buyers.

An important disadvantage of applying a tumbling process as described above for the purpose of ageing stones is that the stones exit the drum in a disordered manner. It will be clear that it is possible to pile up again tumbled stones after the tumbling process, for example by means of a sorting machine. However, this is laborious and expensive. Therefore, the stones are often delivered in a disordered heap, possibly in a big bag. However, there are disadvantages associated with such a way of delivering aged stones.

In the first place, displacing of stones from the heap to a place where they are processed often needs to take place manually, because it is difficult or even impossible to displace the stones mechanically. A lot of common machines are adapted to displacing ordered layers of stones.

In the second place, a heap of stones takes more space than an ordered package of stones.

In the third place, stones often become dirty and green when they are located in a loosely dumped heap, because the heap cannot be packed in a sealing.

In the fourth place, in the case of loosely dumped stones, the quantity is related to the weight of the heap of stones. However, the weight of the stones is not a constant, but dependent of, for example, the weather conditions: a stone weighs more as the stone contains more moisture. Therefore, it would be desirable to relate the quantity to the volume, but the volume of a heap of loosely dumped stones is difficult to determine.

A disadvantage of an application of big bags is that it is troublesome to empty the big bags. Moreover, the big bags are expensive and produce a considerable quantity of waste.

In Belgian patent 1010944, a method for ageing a single layer of stones is described. During the ageing process, the stones remain ordered in the layer. Due to this, it is easier to arrange the stones in a package than in case the stones exit a drum in a mixed-up fashion.

According to the known method, a layer of stones is positioned between two plates, after which at least one of the plates is activated to perform a vibratory movement. As a result of the vibratory movement of the at least one plate, the stones continually get into contact with the plates and with each other, wherein pieces fly off the stones and the stones consequently obtain an aged appearance.

In the known method, measures need to be taken to position several layers of stones on top of each other in order to obtain an ordered package of stones. In the process, a stacker having a clamping system may for example be applied.

In U.S. Pat. No. 6,279,291, a method for ageing stones is also described, wherein the stones are treated between two plates, and wherein at least one of the two plates is activated to perform a vibratory movement. In one of the shown exemplary embodiments, two layers of stones are treated.

It is an objective of the present invention to provide a method for ageing stones, wherein the stones are treated as a package and can be further transported as a package after the ageing process, without any additional dealings being required to arrange the stones, and wherein all stones of the package get aged to a sufficient degree, irrespective of the size of the package.

The objective is achieved by a method comprising the steps of locking a package of stones in a locking member with play being present, and of moving the locking member, wherein the locking member performs at least one rotary movement about a rotation axis, wherein a movement of the stones with respect to the locking member and with respect to each other is brought about, wherein collisions between the stones and between outer stones of the package and the locking member take place, and wherein alteration of the position and/or the orientation of the stones in the package is prevented.

When the method according to the present invention is applied, a package of stones can be aged in its entirety, without the mutual configuration of the stones being lost. The stones are locked in a locking member with play being present, wherein the play can be such that movement of the stones with respect to the locking member and with respect to each other is possible, while the stones are not capable of moving every which way or turn over unrestrictedly. During a rotary movement of the locking member, the stones collide against each other, and outer stones also collide against walls of the locking member. As a result of the collisions, pieces fly off the edges and the corners of the stones, and scratches and grooves appear on the surface of the stones, whereby the stones obtain an aged appearance. During the movement and the collisions, the mutual configuration of the stones does not change; if the play is small enough, the package is kept in shape by the locking member, as it were. Consequently, the package can be removed from the locking member in its entirety after the processing of the stones. Therefore, no additional dealings are required to arrange or pile up the stones, which is an important advantage with respect to known methods for ageing stones.

According to the present invention, the locking member is activated to perform a rotary movement in order to subject the package of stones in its entirety to a rotary movement. By the choice of a rotary movement, it is guaranteed that all stones present in the locking member are put in motion during a movement of the locking member. In the process, among other things, gravity plays a considerable role.

The method according to the present invention offers good possibilities of treating packages of stones having at least two adjacent columns of at least two stones piled on top of each other, wherein the packages can be many times larger the minimum. With respect to the method according to the state of the art in which vibrating plates are applied, the method according to the present invention has, among other things, the advantage that it is easier to put all stones in motion by means of a rotary movement of the locking member. Transmitting a vibratory movement of plates via a layer of stones which is located more closely to a vibrating plate, to a layer of stones which is located further away from this plate is less effective, because the transfer of the vibratory movement is accompanied by absorption of kinetic energy in the former layer of stones. This makes the method according to the state of the art less suitable for treating relatively large packages of stones, which comprise considerably more than two columns of stones of considerably more than two, for example ten, stones piled on top of each other.

The present invention will be explained in greater detail on the basis of the following description of a number of possible embodiments of an ageing device with reference to the drawing, in which equal reference signs indicate equal or similar parts, and in which:

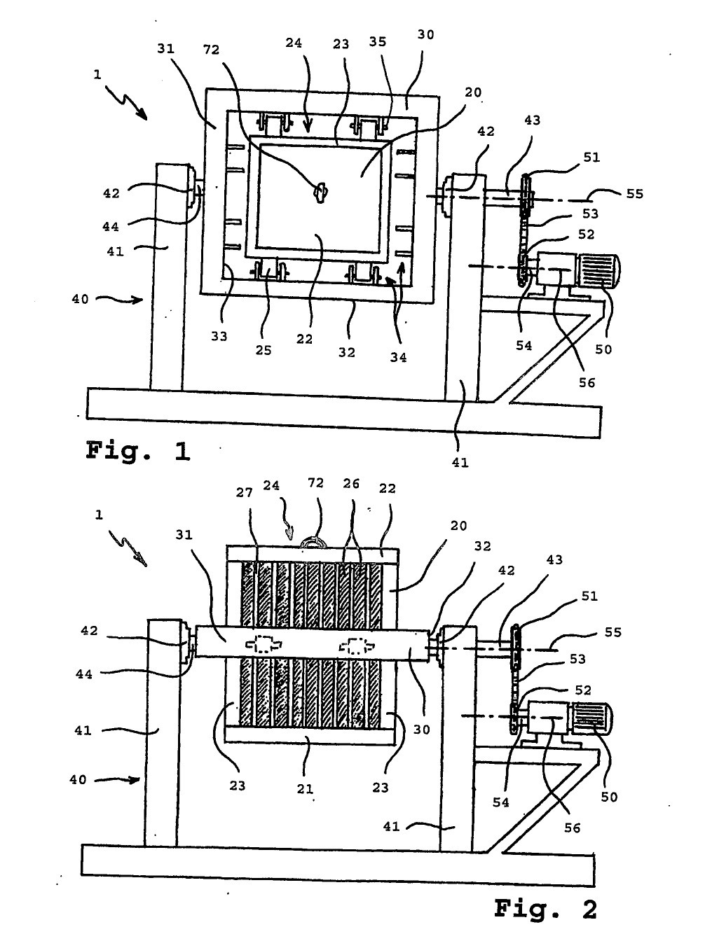

FIG. 1 is a diagrammatical front view of an ageing device according to a first preferred embodiment of the present invention, wherein a rotatable frame of the ageing device is shown in a first possible position;

FIG. 2 is a diagrammatical front view of the ageing device shown in FIG. 1, wherein the rotatable frame has rotated a quarter turn with respect to the first position shown in FIG. 1;

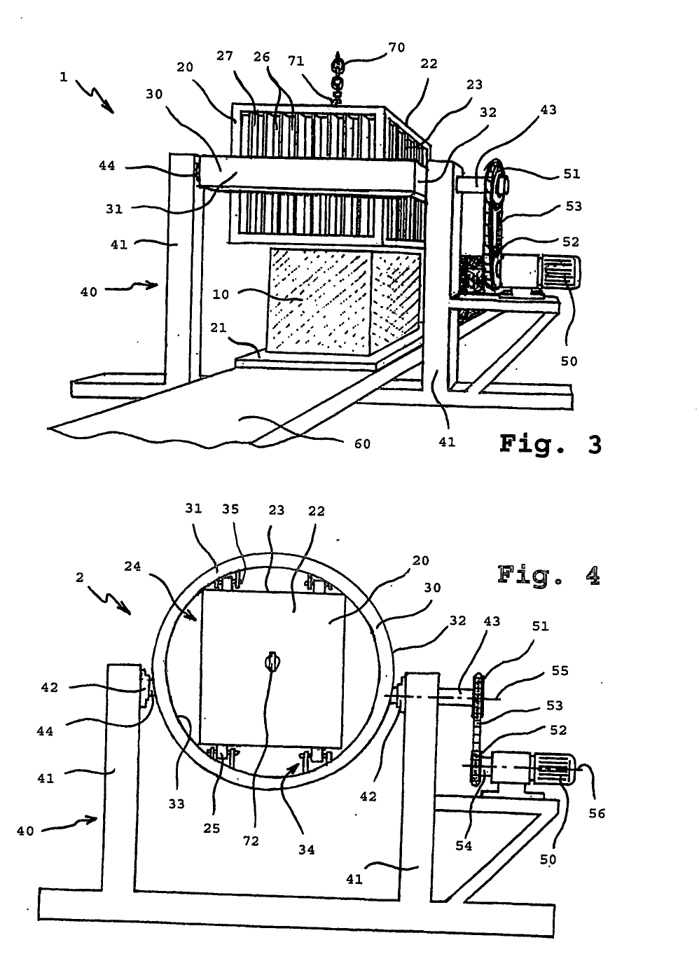

FIG. 3 is a diagrammatical perspective view of the ageing device shown in FIGS. 1 and 2, and also of a portion of a conveyor belt and a portion of a hoisting device; and

FIG. 4 is a diagrammatical front view of an ageing device according to a second preferred embodiment of the present invention.

FIGS. 1-3 show an ageing device 1 according to a first preferred embodiment of the present invention. In the ageing device 1, a package of stones 10 can be received with play and be moved in order to age the stones.

When the ageing device 1 is applied, various different sorts of stones can be processed, for example, concrete stones, bricks, natural stones and tiles.

For the purpose of receiving the package of stones 10, the ageing device 1 comprises a bottom plate 21, on which the package 10 is to be placed prior to the ageing treatment. Further, the ageing device 1 comprises a sleeve 20 which can be pulled over the package of stones 10, and which can be attached to the bottom plate 21. In the example shown in FIGS. 1-3, the sleeve 20 comprises five plates, i.e. a top plate 22 and four side plates 23. When the sleeve 20 is connected to the bottom plate 21, the entirety of bottom plate 21, top plate 22 and side plates 23 forms a cage 24 having the shape of a closed box. The connection between the sleeve 20 and the bottom plate 21 can be realized in any suitable way.

The plates 22, 23 of the sleeve 20 may be substantially planar, as is the case in the shown example. However, it is also possible that the plates 22, 23 have another shape. More in particular, it is a possibility that the plates 22, 23 are provided with irregularities at the inside, which can contribute to the ageing process of the stones.

In a suitable embodiment, at least one of the plates 21, 22, 23 is provided with openings for letting pass stone grit which is formed in the cage 24 during the ageing process-. In this way, at least a portion of, for example, a side plate 23 can be provided with elongated openings 26, wherein the intermediate portions of the side plate 23 form bars 27. It will be clear that the proportions of the openings 26 need to be such that the openings 26 are prevented from letting pass stones from the package 10 locked in the cage 24.

Advantageously, the inner dimension of the cage 24 is 4 adjustable, so that the inner dimension can be adapted to the proportions of a package of stones 10 to be received. The cage 24 has to be capable to receive a package of stones 10 with play, but the play may not be so large that the mutual configuration of the stones in the package 10 could get lost during a movement of the cage 24. Instead, the play needs to be such that the stones have only limited space to move, so that they are not capable of leaving their place in the package 10, and so that they can not turn over so far that their orientation changes. In the case of the shown cage 24, it can be argued that when a package of stones 10 rests against the bottom plate 21 and two adjoining side plates 23 without play, and play is present between the package of stones 10 and the other two side plates 23 and the top plate 22, wherein this play is smaller than the smallest proportion of the stones in the relevant direction from the package 10 to the relevant plate 22, 23, the ageing process of the stones can take place in a suitable manner, wherein the position and orientation of the stones in the package 10 can be preserved.

Being adjustable of the inner dimension of the cage 24 can be realized in different suitable manners. In a suitable embodiment, the position of a number of plates 22, 23 can be varied with respect to the other plates 21, 23. The adjustment of the position of a plate 22, 23 may take place in a manual manner, but may, for example, also be realized in a hydraulic manner.

The ageing device 1 comprises a rotatable frame 30, which is suitable for receiving the cage 24. In the example shown in FIGS. 1-3, the frame 30 comprises four beams 31. It is true for each beam 31 that an end of the beam 31 is connected to an end of another beam 31, so that the frame 30 has the shape of a closed square.

The frame 30 is suspended in a supporting structure 40, which comprises two standing beams 41. On two opposite beams 31 of the frame 30, shafts are arranged, which extend substantially perpendicular to an outer surface 32 of the frame 30. The shafts are bearing-mounted in bearings 42 which are located close to the ends of the standing beams 41. One of both shafts is a driven shaft 43, while another of both shafts is a supporting shaft 44, which is not directly driven. The driven shaft 43 extends through the standing beam 41, and is provided with a first gear 51, at a free end. The first gear 51 is connected to a second gear 52 by means of a chain 53, which second gear 52 is located close to an end of an output shaft 54 driven by a motor 50. In FIGS. 1 and 2, a rotation axis of the first gear 51 is indicated by means of the reference numeral 55, while a rotation axis of the second gear 52 is indicated by means of the reference numeral 56.

When the output shaft 54 is driven by the motor 50, this output shaft 54 rotates about the rotation axis 56. Consequently, the second gear 52 rotates about the rotation axis 56 as well. The chain 53 is put in motion by the rotary movement of the second gear 52, whereby a rotary movement of the first gear 51 about the rotation axis 55 is brought about. The rotary movement of the first gear 51 brings along a rotary movement of the driven shaft 43. As the frame 30 is rigidly connected to the driven shaft 43, and the supporting shaft 44 is rigidly connected to the frame 30, both the frame 30 and the supporting shaft 44 are put in rotation by means of a rotation of the driven shaft 43.

In the way described in the preceding paragraph, a rotation of the output shaft 54 of the motor 50 leads to a rotation of the frame 30 about the rotation axis 55. The nature of the rotary movement of the frame 30 becomes apparent from a comparison of FIGS. 1 and 2, because the position of the frame 30 as shown in FIG. 1 differs a quarter turn from the position of the frame 30 as shown in FIG. 2.

It will be clear to a person skilled in the art that, within the scope of the present invention, a lot of different possibilities exist for the way in which the drive of the driven shaft 43 can take place. Preferably, drive takes place via a transmission, wherein the transmission can comprise gears 51, 52 and a chain 53, like in the shown example, but, for example, also gears and a toothed belt or V-belt pulleys and a V-belt.

On the inner surface 33 of the frame 30, receiving members 34 are arranged, wherein a pair of receiving members 34 is located on every beam 31. The positions of the receiving members 34 are adapted to the positions of fastening shafts 25, which are arranged on the outside of the sleeve 20. When the cage 24 is placed in the frame 30, and the cage 24 needs to be connected to the frame 30, an engagement between the fastening shafts 25 and the receiving members 34 is realized. In a suitable embodiment, the connection between the fastening shafts 25 and the receiving members 34 is detachable in a simple manner. For example, this connection can be secured by means of locking pins 35, of which one end is thickened, and which are fixed by arranging a split pin or the like in another end.

In the example shown in FIG. 1, the sleeve 20 is provided with two pairs of fastening shafts 25, which are located on opposite side plates 23 of the sleeve 20. Each beam 31 of the frame 30 is provided with two pairs of receiving members 34. When the cage 24 is connected to the frame 30, only half of the number of receiving members 34 is involved in establishing the connection, namely only the half which gets into contact with the fastening shafts 25. An important advantage of the presence of a double set of receiving members 34 becomes apparent when the fact that the frame 30 is rotatable about only one rotation axis 55 is considered. During rotating a package of stones 10, fewer collisions will take place in the direction of the rotation axis 55 than in other directions. In order to guarantee that the stones obtain an evenly aged appearance over their entire surface, the package of stones 10 can be turned a quarter turn about a rotation axis which extends perpendicular with respect to the rotation axis 55 after having been rotated a certain amount of time, and then be rotated again during a certain amount of time. The double set of receiving members 34 allows for positioning the cage 24 in the two different positions with respect to the frame 30.

In FIG. 3, a conveyor belt 60 and a portion of a hoisting chain 70 having a hook 71 are depicted, which can be applied in combination with the ageing device 1. The conveyor belt 60 serves for transporting packages of stones 10 from and to the ageing device 1. The hoisting chain 70 is connected to a hoisting eye 72 which is located on the top plate 22 of the sleeve 20, via the hook 71. When the hoisting chain 70 is applied, the sleeve 20 can be hoisted up and lowered.

In the following, a possible way in which a package of stones 10 can be aged while applying the ageing device 1 according to the present invention is described.

A package of stones 10 is supplied to the ageing device 1, wherein the package 10 is located on a bottom plate 21, which is placed on the conveyor belt 60. The package 10 is positioned underneath the sleeve 20, which is in a hoisted-up condition. Subsequently, the sleeve 20 is lowered, until the side plates 23 touch the bottom plate 21, and the package 10 is fully enclosed by the bottom plate 21 and the sleeve 20.

In view of a good course of the ageing process of the stones and the preservation of the positions and orientations of the stones in the package 10, play needs to be present between the plates 22, 23 of the sleeve 20 and the package 10, wherein the size of the play is dependent of the proportions of the stones. Possibly, the position of one or more plates 22, 23 of the sleeve 20 is adapted, until the play is such that the stones can not get orientated differently and can not move every which way when the package 10 is subjected to a movement while the package 10 is located in a space which is limited by the bottom plate 21 and the plates 22, 23 of the sleeve 20. That is the case when the play between the package 10 and the top plate 22 is smaller than the smallest proportion of the stones in a direction from the bottom plate 21 to the top plate 22 when the package 10 rests on the bottom plate 21, and when the play between the package of stones 10 and a side plate 23 is smaller than the smallest proportion of the stones in a direction from the side plate 23 to an opposite side plate 23 when the package 10 rests against the opposite side plate 23.

When the sleeve 20 is positioned over the package 10, and the side plates 23 of the sleeve 20 touch the bottom plate 21, and when the inner dimension of the sleeve 20 is adapted to the proportions of the package 10 in the way described in the preceding paragraph, the sleeve 20 is connected to the bottom plate 21. The entirety of sleeve 20 and bottom plate 21 forms a cage 24 in which the package of stones 10 is locked.

In a next step, the cage 24 with the package of stones 10 needs to be suspended in the frame 30 of the ageing device 1. To this end, the cage 24 is hoisted up while applying the hoisting chain 70, until the fastening shafts 25 on the outside of the cage 24 engage the receiving members 34 on the inner surface 33 of the frame 30.

Subsequently, the hook 71 is detached from the hoisting eye 72, after which the cage 24 with the stones and the frame 30 can be rotated. Ageing of the stones takes place during a rotary movement of the cage 24. For the purpose of the rotary movement, the motor 50 is activated. A rotation of the output shaft 54 of the motor 50 brings about a rotation of the cage 24 about the rotation axis 55, via the-second-gear 52, the chain 53, the first gear 51, the driven shaft 43 and the frame 30. The rotation may be regular, but may, for example, also take place in an intermittent manner. The rotation may take place in one direction, but may also take place in two opposite directions, in other words, the cage 24 may be subjected to a reciprocating rotating movement.

As a result of the rotation of the cage 24, the stones which are present in the cage 24 continually exercise a grinding action on each other and collide with each other. Due to this, small pieces are broken off the edges and the corners of the stones. Also, due to this, scratches and grooves appear on the surface of the stones. In this way, in the course of time, an aged appearance is obtained.

Actually, a stone at the outside of the package 10 does not only get aged under the influence of contact with adjacent stones, but also under the influence of contact with an adjacent plate 21, 22, 23 of the cage 24.

After a certain amount of time, the movement of the frame 30 and the cage 24 is stopped, and the hook 71 of the hoisting chain 70 is inserted in the hoisting eye 72 which is located on the cage 24, after which the connection between the fastening shafts 25 of the cage 24 and the receiving members 34 of the frame 30 is detached. Subsequently, the cage 24 is moved out of the frame 30, which can take place both by hoisting up the cage 24 by means of the hoisting chain 70 and by lowering the cage 24 by means of the hoisting chain 70. When the cage 24 is free, the cage 24 is turned a quarter turn, while hanging on the hoisting chain 70. Subsequently, the cage 24 is moved in the direction of the frame 30 again, by means of the hoisting chain 70, and a connection is brought about between the fastening shafts 25 of the cage 24 and the receiving members 34 of the frame 30. In that situation, the fastening shafts 25 are connected to other receiving members 34 than in the earlier situation. After the connection has been realized, the hook 71 is detached from the cage 24 again, the motor 50 is activated, and the frame 30 and the cage 24 are rotated during a certain amount of time.

After the cage 24 with the package of stones 10 has been rotated in two different orientations in the ageing device 1, the ageing process of the stones has been completed. In order to remove the package of stones 10 from the ageing device 1, the following steps are successively passed through:
the hook 71 of the hoisting chain 70 is inserted in the hoisting eye 72 which is located on the cage 24;
the cage 24 is disconnected from the frame 30 by detaching the connection between the fastening shafts 25 of the cage and the receiving members 34 of the frame;
the cage 24 is lowered to the conveyor belt 60, which is idle at that time;
the connection between the sleeve 20 and the bottom plate 21 is detached;

the sleeve 20 is hoisted up, until the package of stones 10 is completely free; and
the conveyor belt 60 is put in motion.

The package of stones 10 exits the ageing device 1 in the same shape as in which it has entered the ageing device 1. The arrangement of the stones is unaltered with respect to the initial situation. In fact, the only difference between the initial situation and the final situation is that the appearance of the stones has changed as a result of the ageing process.

Preferably, the removed package of aged stones is packed in a seal or the like, and is subsequently ready to be brought to a buyer.

FIG. 4 shows an ageing device 2 according to a second preferred embodiment of the present invention.

An important difference between the ageing device 1 according to the first preferred embodiment of the present invention and the ageing device 2 according to the second preferred embodiment of the present invention relates to the frame 30. The frame 30 shown in FIG. 4 has a circular shape instead of a square shape. At the inside of the frame 30, an annular gear ring (not shown) is located, for example in a groove which is arranged in the inner surface 33 of the frame 30. The gear ring is rotatable with respect to an outer portion 31 of the frame 30, which is fixedly connected to the shafts 43, 44. At the inner circumference of the gear ring, four receiving members 34 are arranged, at positions which are adapted to the positions of the fastening shafts 25 which are located on the outside of the sleeve 20.

When the ageing device 2 according to the present invention is applied, it is not necessary to detach the cage 24 from the frame 30 and move the cage 24 out of the frame 30 and subsequently move the cage 24 back into the frame 30 again and connect the cage 24 to the frame 30 again in order to turn the cage 24 a quarter turn about an axis perpendicular to the rotation axis 55. Instead, the cage 24 can remain in the frame 30. The only thing that is necessary for a rotation of the cage 24 with respect to the frame 30 is a rotation of the ring gear with respect to the outer portion 31 of the frame 30. It will be clear that locking means are provided to fixedly connect the ring gear to the outer portion 31 of the frame 30. Preferably, such locking means are easily put from a locked condition in an unlocked condition, and vice versa.

An important advantage of subjecting a complete package of stones 10 to an ageing process, wherein the configuration of the stones is maintained during the ageing process, is that a good control of the extent to which the stones get damaged is possible. In comparison with a situation in which the stones move chaotically through a drum, collisions take place under more controlled circumstances. There is no reject, because the stones can riot get too severely damaged; all stones of the package 10 are suitable to be applied further.

It will be clear to a person skilled in the art that the-scope of the present invention is not limited to the examples discussed above, but that several amendments and modifications thereof are possible without deviating from the scope of the invention as defined in the appended claims.

The described method for ageing a package of stones is applicable to various sorts of stones, irrespective of, for example, the material and the size of the stones.

In the first preferred embodiment of an ageing device 1 according to the present invention as described on the basis of FIGS. 1-3, the cage 24 is provided with four fastening shafts 25, and the frame 30 is provided with eight receiving members 34. However, it is also possible that the cage 24 is provided with a double set of fastening shafts 25, i.e. eight fastening shafts 25, and that the frame 30 is provided with a single set of receiving members 34, i.e. four receiving members 34. It will be clear that the number of fastening shafts 25 and receiving members 34 is not determined within the scope of the present invention. It is important that the quantity of fastening shafts 25 and receiving members 34 is such that the cage 24 can be suspended in the frame 30 in a reliable manner. Apart from that, other suitable means for interconnecting the cage 24 and the frame 30 than the shown fastening shafts 25 and receiving members 34 may also be applied.

Advantageously, when applying such means, it is possible in a simple manner to realize a coupling between the cage 24 and the frame 30 on the one hand and an uncoupling of the cage 24 and the frame 30, on the other hand.

In the shown examples, the package of stones 10 in the cage 24 is subjected to a rotary movement about a single rotation axis 55. Within the scope of the present invention, this is not essential. For example, the case 24 may also be subjected to a certain swinging movement which is composed of several rotary movements which simultaneously take place, each about an associated rotation axis. It is also for example possible that the cage 24 is additionally activated to perform a vibratory movement.

The application of a rotatable frame 30 in which the cage 24 is suspended may be omitted. For example, the cage 24 itself may be provided with a driven shaft 43 and a supporting shaft 44.

Advantageously, the stones are supplied as package 10 to the ageing device 1, 2, and removed from the ageing device 1, 2 as package 10 after the ageing process. However, this is not necessary; for the method for ageing the package 10, it is not significant how the stones are supplied and how the stones are removed again. In any case, during the ageing process, the stones are arranged in a package 10. However, the method in which a complete package of stones 10 is aged, offers the important advantage that the stones can be supplied and removed while being arranged in a package 10.

With respect to the shown examples of the ageing devices 1, 2, different measures are described for turning the cage 24 a quarter turn with respect to the frame 30 in order to guarantee that the stones get an aged appearance over their entire surface. In the first example, the cage 24 is taken out of the frame 30 and subsequently inserted into the frame 30 again in an altered position. In the second example, it is not necessary to take the cage 24 out of the frame 30, because the position of the cage 24 with respect to the frame 30 can be altered while the cage 24 is present in the frame 30.

It will be clear that more possibilities exist for realizing that the cage 24 performs two successive rotary movements about different rotation axes. For example, it is possible that each of two opposite sides of the cage 24 is connected to the frame 30 via a shaft in such a way that the cage 24 is rotatable with respect to the frame 30. In such an embodiment, the position of the cage 24 with respect to the frame 30 can be adapted in an exceedingly simple manner. For example, the frame 30 is U-shaped, wherein the shafts between the cage 24 and the frame 30 are attached to the legs of the frame 30, while a central portion of the basis of the frame 30 is connected to the other parts of the ageing device in such a way that the frame 30 is rotatable with respect to said parts. Further, it is for example possible that only one side of the cage 24 is connected to the frame 30 via a shaft, and that the cage 24 can rotate with respect to the frame 30 via this single shaft. In such a case, the frame can also be U-shaped, wherein the cage 24 is rotatably connected to the basis of the frame 30, while both ends of the legs of the frame 30 are rotatably connected to the other parts of the ageing device. Apart from that, both in this case and the case described prior to this case, the cage 24 is located between the legs of the frame 30.

An important similarity between the possible embodiments described in the preceding paragraph and the embodiment described on the basis of FIG. 4 is that the cage 24 is rotatably arranged with respect to the frame 30, wherein the cage 24 can be secured in different positions with respect to the frame 30.

In the foregoing, among other things, a device 1, 2 for ageing a package of stones 10 is described, which device 1, 2 comprises a cage 24 for locking the package of stones 10 with play being present. For the purpose of the ageing process of the stones, the cage 24 is suspended in a frame 30 which is rotatable about a rotation axis 55.

During a rotary movement of the frame 30 and the cage 24, the stones collide against each other, and outer stones of the package 10 additionally collide against plates 21, 22, 23 of the cage 24. The play between the package of stones 10 and the cage 24 is chosen such that the stones have space to move on the one hand, and that the position and the orientation of the stones in the package 10 are maintained on the other hand. Consequently, after the ageing process has finished, the stones can be removed from the ageing device 1, 2 as an ordered package 10.

According to a first important aspect of the present invention, the frame 30 is provided with a driven shaft 43, which is preferably driven by a motor 50, preferably via a transmission.

According to a second important aspect of the present invention, the frame 30 is provided with first coupling means 34, wherein the locking member 24 is provided with second coupling means 25 which are designed to engage the first coupling means 34.

According to a third important aspect of the present invention, an arrangement having an ageing device 1, 2 according to the present invention and conveyor means 60 for supplying and removing a package of stones 10 also comprises a manipulator 70, 71 for manipulating the locking member 24 of the ageing device 1, 2.

According to a fourth important aspect of the present invention, a manipulator as described in the preceding paragraph comprises a hoisting chain 70, which at one end is provided with a hook 71, wherein the locking member 24 of the ageing device 1, 2 is provided with a hoisting eye 72 for receiving the hook 71.

1-12. (canceled)

13. Method for ageing a package of stones having at least two adjacent columns of at least two stones piled on top of each other, comprising the following steps:
locking a package of stones in a locking member with play being present; and
moving the locking member, wherein the locking member performs at least one rotary movement about a rotation axis, wherein a movement of the stones with respect to the locking member and with respect to each other is brought about, wherein collisions between the stones and between outer stones of the package and the locking member take place, and wherein alteration of the position and/or the orientation of the stones in the package is prevented.

14. Method according to claim 13, wherein the locking member performs a reciprocating movement about the rotation axis.

15. Method according to claim 13, wherein the locking member successively performs a rotary movement about the rotation axis in two different directions.

16. Method according to claim 13, wherein a distance between an outer stone of the package and the locking member is always smaller than the proportion of the stone in a direction in which the distance is determined.

17. Device for ageing a package of stones having at least two adjacent columns of at least two stones piled on top of each other, comprising:
a locking member for locking the package of stones with play being present, wherein an inner dimension of the locking member is adjustable; and
a rotatably arranged frame for receiving the locking member.

18. Ageing device according to claim 17, wherein the locking member is provided with at least one opening for letting pass stone grit which is formed in the locking member during the ageing process.

19. Ageing device according to claim 17, wherein the frame is provided with first coupling means, wherein the locking member is provided with second coupling means which are designed to engage the first coupling means, and wherein at least one of the locking member and the frame is provided with a double set of coupling means.

20. Ageing device according to claim 17, wherein the position of the locking member with respect to the frame is adjustable.

21. Ageing device according to claim 20, wherein the locking member is rotatably arranged with respect to the frame.

22. Ageing device according to claim 20, wherein the frame is provided with first coupling means, wherein the locking member is provided with second coupling means which are designed to engage the first coupling means, and wherein the position of the first coupling means with respect to the frame is adjustable.

23. Ageing device according to claim 22, wherein the frame comprises a fixed portion and a portion which is rotatable with respect to the fixed portion, wherein the first coupling means are arranged on the rotatable portion.

24. Arrangement for ageing a package of stones having at least two adjacent columns of at least two stones piled on top of each other, and also for supplying and removing the package of stones, comprising:
conveyor means for transporting the package of stones, which conveyor means preferably comprise a conveyor belt; and
an ageing device according to claim 17.
